(19) United States
(12) Patent Application Publication
(10) Pub. No.: US 2004/0141579 A1
(43) Pub. Date: Jul. 22, 2004

(54) Storage/transport container for damaged nuclear-fuel elements

(75) Inventors: Dieter Methling, Hattingen (DE); Jurgen Wriegt, Heiligenhaus (DE); Felix Thomas, Bedburg (DE)

Correspondence Address: THE FIRM OF KARL F ROSS, 5676 RIVERDALE AVENUE, PO BOX 900, RIVERDALE (BRONX), NY, 10471-0900, US

(73) Assignee: GNB Gesellschaft fur Nuklear-Behalter mbH

(21) Appl. No.: 10/737,718

(22) Filed: Dec. 16, 2003

(30) Foreign Application Priority Data
Jan. 18, 2003 (EP) 03001068.0

(51) Int. Cl. G21C 19/00

(52) U.S. Cl. 376/272

(57) ABSTRACT

A storage/transport container for intact and broken nuclear-fuel elements has a vessel defining an interior extending along an axis and a plurality of like basket sections forming a stack extending substantially a full axial length of the interior and forming a plurality of axial full-length rectangular-section wells. Respective metal tubes extending substantially the full length of some of the wells are of complementary section to the respective wells and are each adapted to snugly hold an intact spent nuclear-fuel element. At least one box extending substantially the full length of others of the wells is of complementary section to the respective well and is adapted to hold pieces of a broken spent nuclear-fuel element.

### FIELD OF THE INVENTION

The present invention relates to storage/transport container. More particularly this invention concerns such a container specifically designed for spent nuclear-fuel elements.

### BACKGROUND OF THE INVENTION

As described in U.S. Pat. No. 6,256,363, a transport/storage container for spent nuclear-fuel elements has a vessel having a side wall with an inner surface defining an interior extending along an axis and a plurality of like basket sections forming a stack extending substantially a full axial length of the interior and forming a plurality of axial full-length rectangular-section wells adapted to receive the spent fuel elements. Each of the basket sections is formed of two long light-metal neutron-absorbing plates crossing each other, each having a pair of outer ends directly engaging the inner surface of the side wall in heat-transmitting contact therewith, and subdividing the interior at the respective section into a plurality of segments. A plurality of short light-metal neutron absorbing plates are fitted together in each of the segments and form with the main plates of the respective section rectangular-section axially throughgoing openings forming the wells with the plates of the other sections. A respective light-metal tube extends substantially the full length of each of the wells. The spent nuclear-fuel elements are within the light-metal tubes. These tubes are each provided with axial guide passages and is provided therein with neutron-absorbing rods. Each tube is of the same square or rectangular section as the respective well and fits tightly therein so that these tubes considerably rigidify the system, holding the basket sections in accurate axial alignment with one another. These tubes can be of stainless steel.

This container can be produced simply and inexpensively, yet safely holds the fuel elements or rods while shielding radiation and dissipating heat they generate. The main problem comes when the elements are damaged, as they are quite brittle so can be broken during handling when being extracted from the reactor and moved to the storage/transport container.

Such broken rods must be encased in some sort of shielding and, when thus shielded, cannot fit in the standard tubes which are dimensioned to closely fit the intact rods. It is impractical to redesign the containers to accommodate such broken rods, as such redesign entails considerable construction costs for the container which is typically a single-use item of considerable complexity.

### OBJECTS OF THE INVENTION

It is therefore an object of the present invention to provide an improved storage/transport container for spent nuclear-fuel elements.

Another object is the provision of such an improved storage/transport container for spent nuclear-fuel elements which overcomes the above-given disadvantages, that is which can accommodate broken elements.

### SUMMARY OF THE INVENTION

A storage/transport container for intact and broken nuclear-fuel elements has according to the invention a vessel defining an interior extending along an axis and a plurality of like basket sections forming a stack extending substantially a full axial length of the interior and forming a plurality of axial full-length rectangular-section wells. Respective metal tubes extending substantially the full length of some of the wells are of complementary section to the respective wells and are each adapted to snugly hold an intact spent nuclear-fuel element. At least one box extending substantially the full length of others of the wells is of complementary section to the respective well and is adapted to hold pieces of a broken spent nuclear-fuel element.

Thus according to the invention broken nuclear-fuel elements are loaded into one of the boxes. One of the wells is stripped of its liner tube or is never equipped with a liner tube, and the box is slipped into this tube-free well. Thus a standard container can be used for storing and/or transporting both intact and broken fuel elements. The intact elements are held as is known in the tubes, whose open ends are covered by the floor and lid of the container. The broken elements are completely contained in the boxes that are made of the same material as the tubes, e.g. stainless steel.

According to the invention each box has a side wall extending the full length of the respective well, a floor plate closing one end of the side wall, a cover plate closing the other end of the side wall, and a latch releasably securing the cover plate to the other end. Thus each box can be loaded outside the container, then closed, then fitted to the container.

In accordance with the invention each side wall is formed adjacent the other end with an inwardly open seat and the latch is pivotal about the axis and includes a radially extending arm engageable in the seat. Thus the box is filled, then its cover plate is fitted in place and the latch is turned to lock the cover.

At least one of the plates is formed with a vent hole. Normally both end plates are. The box has a filter screen over the vent hole(s). This allows the charge in the container to be vacuum dried, with the extracted vapor escaping through the screened vent holes.

To facilitate handling of the boxes, they each have an upper end formed with seats adapted to fit with arms of a grab. This makes it much easier to fill the box outside the container and then slide it down into a tube-free well.

### BRIEF DESCRIPTION OF THE DRAWING

The above and other objects, features, and advantages will become more readily apparent from the following description, reference being made to the accompanying drawing in which:

FIG. 1 is a small-scale perspective top view of an open container according to the invention;

FIG. 2 is a partly sectional large-scale view of the upper end of a liner tube in accordance with the invention; and

FIG. 3 is a partly sectional large-scale view of the lower end of the liner tube.

### SPECIFIC DESCRIPTION

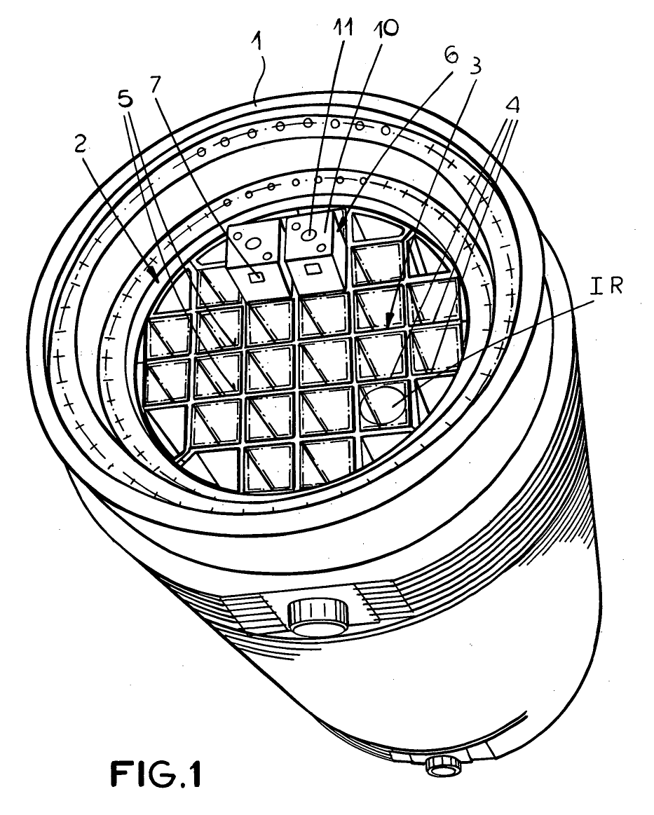

As seen in FIG. 1 a container 1 for spent nuclear fuel elements has a massive and cylindrical side or outer wall centered on a normally upright axis and defining a cylindrical interior space 2. An unillustrated floor plate closes the bottom of the container 1 and an unillustrated lid covers the top. The walls, floor, and lid can include shielding materials, for instance steel with polyethylene shielding. A rack or basket 3 forming a plurality of axially full length wells or passages 4 is itself formed as a stack of levels each formed in turn by neutron-absorbing borated aluminum plates joined together at slide joints. Snugly fitted in some of the wells or passages 4 are respective square-section stainless-steel tubes 5 extending the full axial length of the interior of the container 1 and dimensioned to snugly receive intact fuel-element rods one of which is illustrated at IR. This structure corresponds essentially to that described in above-cited U.S. Pat. No. 6,256,363.

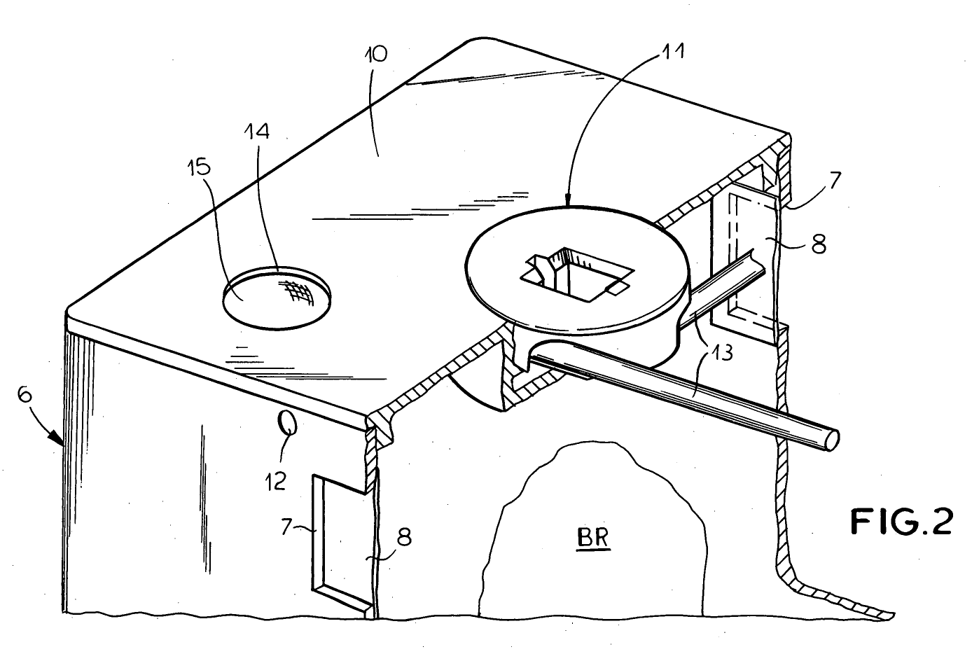

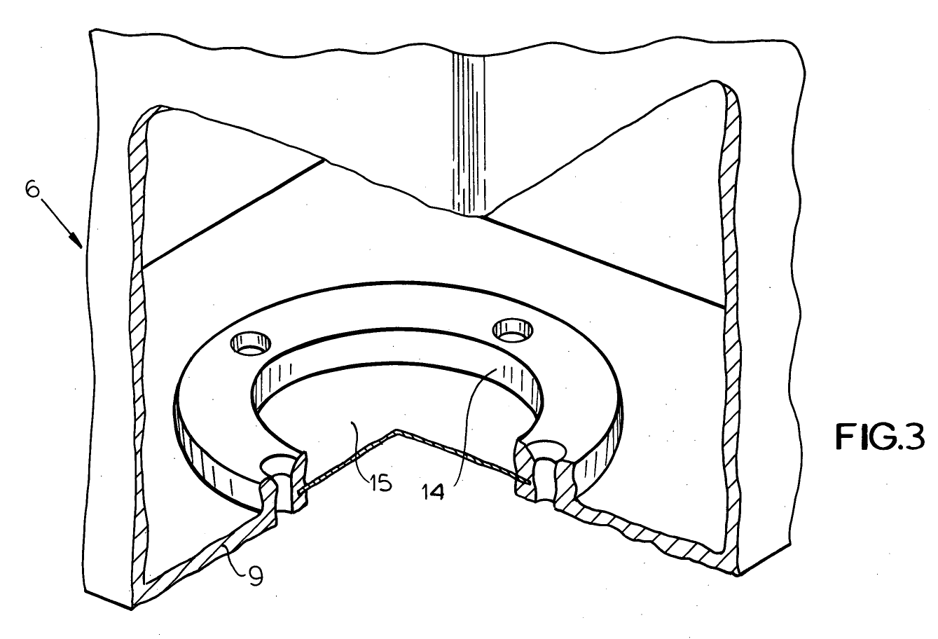

According to the invention as better shown in FIGS. 2 and 3, some of the wells 4 are fitted with square-section boxes 6 that hold broken fuel rods shown schematically in FIG. 2 at BR and that are of the same cross-sectional size as the tubes 5. In fact the same square tubing used to make the liner tubes 5 can be used to make the side walls of the boxes 6. The boxes 6 each have an upper end provided with diametrally opposite and outwardly open seats 7 internally covered by plates 8 that accommodate arms of a grab used to lower the boxes 6 into the respective wells 4. In addition each box 6 has a fixed bottom or floor plate 9 (FIG. 3) and a removable top or cover plate 10 (FIG. 2). The bottom and top plates 9 and 10 are each formed with a vent opening 14 covered by a filter screen 15.

The cover 10 is further provided with a latch 11 that is pivotal about the longitudinal center axis of the box 6 and that has arms 13 that can fit in holes 12 formed adjacent the upper end of the box 6. Thus after broken fuel rods BR are charged into the box 6, the removable cover 10 is fitted in place and secured by means of the latch 11. Then the full box 6, which can in fact hold broken bits and pieces of fuel rods, is lowered by a grab fitted to the seats 7 into one of the wells 4 which has not been provided with a liner tube 5 or from which the liner tube 5 has been removed.

Thus with this arrangement the wells 4 lined with the tubes 5 can accommodate the standard tube-shielded intact fuel rods. In addition the special boxes 6 of identical outside dimensions are usable for holding broken fuel rods. The same container 1 can therefore be used for both intact and broken fuel rods.

We claim:

1. A storage/transport container for intact and broken nuclear-fuel elements
a vessel defining an interior extending along an axis; and
a plurality of like basket sections forming a stack extending substantially a full axial length of the interior and forming a plurality of axial full-length rectangular-section wells;
respective metal tubes extending substantially the full length of some of the wells, of complementary section to the respective wells, and each adapted to snugly hold an intact spent nuclear-fuel element; and
a box extending substantially the full length of another of the wells, of complementary section to the respective well, and adapted to hold pieces of a broken spent nuclear-fuel element.

2. The storage/transport container for intact and broken nuclear-fuel elements defined in claim 1, where in the box has
a side wall extending the full length of the respective well,
a floor plate closing one end of the side wall,
a cover plate closing the other end of the side wall, and
latch means releasably securing the cover plate to the other end.

3. The storage/transport container for intact and broken nuclear-fuel elements defined in claim 2 wherein the side wall is formed adjacent the other end with an inwardly open seat and the latch means is pivotal about the axis and includes a radially extending arm engageable in the seat.

4. The storage/transport container for intact and broken nuclear-fuel elements defined in claim 2 wherein at least one of the plates is formed with a vent hole.

5. The storage/transport container for intact and broken nuclear-fuel elements defined in claim 4 wherein the box has a filter screen over the vent hole.

6. The storage/transport container for intact and broken nuclear-fuel elements defined in claim 1 wherein the box has an upper end formed with seats adapted to fit with arms of a grab.

7. A storage/transport container for intact and broken nuclear-fuel elements
a vessel defining an interior extending along an axis;
a plurality of like basket sections forming a stack extending substantially a full axial length of the interior and forming a plurality of axial full-length rectangular-section wells;
respective metal tubes extending substantially the full length of some of the wells, of complementary section to the respective wells, and each adapted to hold an intact spent nuclear-fuel element;
a plurality of like boxes extending substantially the full length of others of the wells, of complementary section to the respective wells, and each adapted to hold pieces of a broken spent nuclear-fuel element, each box having
a side wall extending the full length of the respective well,
a floor plate closing one end of the side wall,
a cover plate closing the other end of the side wall, and
latch means releasably securing the cover plate to the other end.
